(19) United States
(12) Patent Application Publication
(10) Pub. No.: US 2012/0002885 A1
(43) Pub. Date: Jan. 5, 2012

(54) IMAGE PROCESSING DEVICE

(75) Inventors: Shinya Murakami, Kyoto (JP); Ryogo Yanagisawa, Osaka (JP)

(73) Assignee: Panasonic Corporation, Osaka (JP)

(21) Appl. No.: 13/232,498

(22) Filed: Sep. 14, 2011

Related U.S. Application Data
(63) Continuation of application No. PCT/JP2009/005884, filed on Nov. 5, 2009.

(30) Foreign Application Priority Data
Jun. 23, 2009 (JP) 2009-148522

(51) Int. Cl. G06K 9/68; G06K 9/40

(52) U.S. Cl. 382/218; 382/260; 382/264; 382/263

(57) ABSTRACT

In an image processing device, a lowpass filter extracts a low-frequency component of 8-bit input image data VI1 to obtain 10-bit image data LP1 expanded in the course of an operation during the extraction of the low-frequency component. Two less significant bits of the image data LP1 are rounded in a rounding circuit, and the obtained image data is output as 8-bit image data RD1. A comparator compares the image data RD1 with image data VI2, and an image output control circuit outputs a control signal OC1 based on a result CP1 of the comparison. A bit addition circuit adds 2 bits to the LSB of the image data VI1 to output 10-bit image data BS1. An output image selection circuit selects the image data LP2 or the image data BS2 based on the control signal OC1 to output as 10 bit-image data VO1.

### CROSS-REFERENCE TO RELATED APPLICATION

This is a continuation of PCT International Application PCT/JP2009/005884 filed on Nov. 5, 2009, which claims priority to Japanese Patent Application No. 2009-148522 filed on Jun. 23, 2009. The disclosures of these applications including the specifications, the drawings, and the claims are hereby incorporated by reference in their entirety.

### BACKGROUND

The present invention relates to image processing devices configured to process digital image signals, and specifically to image processing devices configured to improve the tone to reconstitute smooth images.

High-resolution image contents have been increasing along with performance enhancement in digital image processing devices in recent years. Moreover, a high-definition multimedia interface (HDMI) which is an image and audio transmission system is capable of transmitting images in deep-color format using more than 8 bits per image pixel, and the number of reproducing devices supporting deep color outputs has been increasing. Furthermore, the number of displays capable of displaying images with a precision of 8 or more bits has been increasing along with performance enhancement in displays for displaying images.

An image captured by a video camera, or the like is recorded as an analog image on a film, and is converted to digital image data by analog to digital conversion (hereinafter referred to as A/D conversion). However, the quantized bit width of the digital image data obtained by the A/D conversion is limited to about 8 bits because of, for example, reduction in data capacity when the data is stored in a storage medium such as an optical disk.

Since conventional displays had a resolution of about 8 bits to display images, it did not matter if image data to be displayed was in an 8 bit format. However, when images are displayed on a display capable of displaying the images with a high accuracy of 8 or more bits, in particular when image signals which smoothly change, for example, gradient images created by using computer graphics (CG), or the like are displayed, the differences between the least significant bits (LSBs) of groups of 8 bits significantly emerge, and are visible as topographical features on a screen.

As a method to render the quality of images less susceptible to degradation, a bit expanding device described in, for example, Japanese Patent Publication No. H08-237669 has been proposed.

FIG. 1 is a view illustrating an example configuration of the bit expanding device of Japanese Patent Publication No. H08-237669. In the bit expanding device of FIG. 1, for example, an 8-bit image signal 51 is supplied to an input terminal 001, and a 10-bit expanding circuit 002 adds two bits of “0” to the LSB of the image signal 51, so that the image signal 51 is expanded and becomes a 10-bit image signal S2. The 10-bit image signal S2 is sent to a control signal output circuit 020 configured to output a control signal based on the feature of an image of the input image signal 51, and a converting section 030 configured to adaptively convert the image signal S2 to a 10-bit signal based on the control signal from the control signal output circuit 020.

The control signal output circuit 020 includes an adder 005 and a comparator 006. The converting section 030 includes a lowpass filter (LPF) 003, a LSB extraction circuit 004, adders 007, 009, and a switch 008. The signal S2 output from the 10-bit expanding circuit 002 is sent to the lowpass filter 003 and the adder 007 of the converting section 030 and the adder 005 of the control signal output circuit 020. The lowpass filter 003 of the converting section 030 performs filter processing on the 10-bit image signal S2 to output a signal S3. The signal S3 is sent to the LSB extraction circuit 004 and the adder 005 of the control signal output circuit 020. The adder 005 of the control signal output circuit 020 outputs a difference S5 between the signal S3 output from the lowpass filter 003 and the signal S2 output from the 10-bit expanding circuit (S5=S2−S3), and sends the difference S5 to the comparator 006. The comparator 006 compares the difference S5 with a predetermined threshold value, for example, “4” corresponding to 2 bits, and outputs, based on the comparison result, as described later, a control signal C1 to add a lower bit without losing a high-frequency component of the input image signal, and a control signal C2 to control a way to add the lower bit.

The LSB extraction circuit 004 of the converting section 030 extracts only 2 bits from the 10-bits image signal S3 on the LSB side as an output signal S4, and then supplies the output signal S4 to the switch 008. The control signal C1 derived from the comparator 006 is supplied as an ON/OFF control signal to the switch 008. The control signal C2 is supplied to the adder 007, and an output signal from the adder 007 is sent to the adder 009 of the converting section 030. An output signal from the switch 008 is supplied to the adder 009, and an output signal from the adder 009 is derived via an output terminal 010.

Here, the case where the lowpass filter 003 is made of a finite impulse response (FIR) filter, and the transfer function of the FIR filter is indicated by Expression 1 below is considered.

(1+2×Z⁻¹+2×Z⁻²+2×Z⁻³+Z⁻⁴)/8 (Expression 1)

FIG. 2A illustrates an image signal D001 input to the input terminal 001, and a change D002 of the signal S3 output from the lowpass filter 003. FIG. 2B illustrates output image data D003 from the output terminal 010 when the image signal D001 of FIG. 2A is input to the input terminal 001. When the image signal D001 is compared with the output image data D003, it can be seen that the change of the signal is smoothed.

Moreover, as a second method, an image processing apparatus described in Japanese Patent Publication No. 2004-54210 has been proposed.

In the image processing apparatus of Japanese Patent Publication No. 2004-54210, a changing point pixel among closely aligned pixels of an input image has a different value of data from a pixel adjacent thereto, wherein when data in several successive pixels prior to the changing point pixel is the same, and data in the changing point pixel and several successive pixels subsequent to the changing point pixel is the same, bits are linearly expanded so that values of the pixels prior to and subsequent to the changing point pixel smoothly change. FIG. 4 illustrates a change of image data D012 output from the image processing apparatus of Japanese Patent Publication No. 2004-54210 when image data which changes as indicated by the symbol D011 is input to the image processing apparatus of Japanese Patent Publication No. 2004-54210. Since in areas A011, A013, data in successive pixels prior to a data changing point is the same, and data in successive pixels subsequent to the data changing point is the same, bits of the data of the pixels are linearly expanded. In an area A012, the data of the pixels continuously change around the data changing point, and pixels having the same values are not successive, and thus the input data is output without being processed.

Furthermore, as a third method, an image processing apparatus described in Japanese Patent Publication No. 2007-221569 illustrated in FIG. 5 has been proposed.

With the image processing apparatus of Japanese Patent Publication No. 2007-221569, it is possible to obtain a smoothly changing signal when bits of an input image signal are expanded, without depending on the frequency response characteristics of a lowpass filter. In the apparatus described in Japanese Patent Publication No. 2007-221569, as illustrated in FIG. 5, a lowpass filter 041 is used to extract a low-frequency component of an 8-bit input image. Next, the low-frequency component (8 bits or more) output from the lowpass filter 041 is rounded in a rounding process operation section 042, so that image data rounded to 8 bits, which is the same number of bits as the input signal Si, and image data rounded to 10 bits are output from the rounding process operation section 042. An adder 044 subtracts the image data rounded to 10 bits from the input signal Si, and extracts a high-frequency component. Moreover, the image data which is output from the rounding process operation section 042 and is rounded to 8 bits is input to a bit expansion section 046. An adder 047 adds a 10-bit image signal output from the bit expansion section 046 to an image signal output from a subtracter 044, and a limiter 048 limits (s+11) bits to 10 bits, and the limited bits are output. The bit expansion section 046 detects a change of the LSB of the input 8-bit low-frequency signal and an area in which the same values are successive, and adds 2 bits to the LSB of the 8-bit low-frequency signal so that a linear change occurs from a previous changing point to a next changing point when the same values are successive and the amount of change from the previous changing point is the minimum amount of change of 8 bits (1LSB). As a result, in the bit expansion section 046, in the vicinity of the changing point at which the 8-bit low-frequency signal changes by 1LSB (that is, changes by the minimum amount of 8 bits), bit expansion is performed to achieve a linear smooth change.

### SUMMARY

The conventional image processing device improves the tone of the low-frequency portion, and can output a smooth image.

However, in the bit expanding device of Japanese Patent Publication No. H08-237669, undesired noise may occur in a certain area. As an example, the case where an image signal which changes as indicated by the symbol D004 of FIG. 3A is input to the input terminal 001 is considered.

FIG. 3A illustrates the image signal D004 input to the input terminal 001 and a change D005 of the signal S3 output from the lowpass filter 003. The symbol D006 of FIG. 3B indicates a change of the output image data from the output terminal 010 when the image signal D004 of FIG. 3A is input to the input terminal 001. The adder 005 of FIG. 1 computes the difference between the signal S3 (D005) and the signal S2 (D004), and outputs the obtained difference as a difference signal S5. The comparator 006 outputs the control signals C1, C2 to control the output image based on the difference S5. Here, it is provided that a threshold value which the comparator 006 uses for comparison is “4.” In an area A002 of FIG. 3A, the difference between the signal S3 (D005) and the signal S2 (D004) is “4” or greater, and thus addition is performed neither in the adder 007 nor in the adder 009, and the S2 (D004) is output. However, in areas A001, A003, the difference between the signal S3 (D005) and the signal S2 (D004) is “4” or less, and thus the control signal C1 turns on the switch 008, so that addition in the adder 007 and the adder 009 is performed. As a result, as indicated by the symbol D006 of FIG. 3B, noise occurs in the areas A001, A003.

In the image processing device of Japanese Patent Publication No. 2004-54210, bit expansion is performed to allow a linear change in the areas A011, A013 of FIG. 4, and thus it is possible to obtain an image which smoothly changes. However, linear compensation is not applied to the area A012, so that a smooth image cannot be obtained between the area A011 and the area A013. Thus, due to the influence of the area A012, the outline may be visible.

In the image processing device of Japanese Patent Publication No. 2007-221569, the low-frequency component and the high-frequency component are separated from each other, and only the low-frequency component is subjected to image compensation, and then the low-frequency component is added to the high-frequency component to output an image. In the image processing device of Japanese Patent Publication No. 2007-221569, the bit expansion section 046 detects a change and continuity of the output data from the lowpass filter, and based on the information on the change and the continuity, modification is performed to achieve a linear smooth change. However, the modification is not performed on a portion where the amount of change is larger than 2LSB of 8 bits, and in addition, a large memory is required for the modification described above, and thus the circuit scale may be increased.

To solve the problems discussed above, an example image processing device of the present invention is configured to reconstitute an original image from quantized digital image data, and includes: an input unit to which the quantized digital image data is input; a filter unit configured to perform filter processing on first image data output from the input unit; a rounding unit configured to change a bit width of second image data output from the filter unit to a same bit width as the first image data; a comparator unit configured to compare third image data output from the rounding unit to the first image data; an image output controller unit configured to generate a control signal based on a comparison result output from the comparator unit; a bit addition unit configured to add a predetermined number of bits to the first image data; an output image selector unit configured to select the second image data or fourth image data output from the bit addition unit based on the control signal and to output the selected image data; and an output unit configured to output fifth image data output from the output image selector unit to the outside.

In the example image processing device of the present invention, the filter unit is a lowpass filter configured to extract a low-frequency component of the first image data.

In the example image processing device of the present invention, the comparator unit is configured to detect that the first image data matches the third image data.

In the example image processing device of the present invention, the image output controller unit includes a comparison result holding unit configured to hold the comparison result output from the comparator unit or multiple ones of the comparison result output from the comparator unit, and the image output controller unit is configured to generate the control signal based on a predetermined plurality of comparison results of the one or more comparison results held in the comparison result holding unit.

The example image processing device of the present invention further includes a memory unit configured to hold the first image data, wherein instead of the first image data, a vertical image data string output from the memory unit is input to the filter unit, instead of the first image data, sixth image data output from the memory unit is input to the bit addition unit, instead of the first image data, the sixth image data is input to the comparator unit, and the vertical image data string includes the sixth image data.

In the example image processing device of the present invention, the bit addition unit includes a highpass filter configured to extract a high-frequency component of the first image data, and an adder unit configured to add the high-frequency component of the first image data output from the highpass filter to the first image data, and the bit addition unit outputs data output from the adder unit as the fourth image data.

Thus, the present invention is capable of outputting a high-tone smooth image without undesired noise or undesired outlines in a certain area.

As described above, the image processing device of the present invention is capable of outputting a high-tone smooth image without degrading an input image when the bit width of quantized image data is expanded, and the image data having the expanded bit width is output.

### BRIEF DESCRIPTION OF THE DRAWINGS

FIG. 1 is a block diagram illustrating an example configuration of a bit expanding device of Japanese Patent Publication No. H08-237669.

FIGS. 2A, 2B are views illustrating operation of the bit expanding device of FIG. 1, where FIG. 2A is a view illustrating changes of an image signal input to an input terminal and an output signal from a lowpass filter, and FIG. 2B is a view illustrating output image data from an output terminal when the image signal of FIG. 2A is input to the input terminal.

FIGS. 3A, 3B are views illustrating a problem of the bit expanding device of FIG. 1, where FIG. 3A is a view illustrating the image signal input to the input terminal, and FIG. 3B is a view illustrating a change of the output image data from the output terminal when the image signal of FIG. 3A is input to the input terminal.

FIG. 4 is a view illustrating operation of an image processing device of Japanese Patent Publication No. 2004-54210.

FIG. 5 is a block diagram illustrating an example configuration of an image processing device of Japanese Patent Publication No. 2007-221569.

FIG. 6 is a block diagram illustrating an example configuration of an image processing device of a first embodiment of the present invention.

FIGS. 7A, 7B are views illustrating operation of controlling input data and output data of the image processing device, where FIG. 7A is a view illustrating a change of the value of image data and a change of data after passing through a lowpass filter, and FIG. 7B is a view illustrating changes of a comparison result from a comparator and a control signal from an image output control circuit when the image data of FIG. 7A is input.

FIG. 8 is a view illustrating an output data when the image data of FIGS. 7A, 7B is input by the image processing device.

FIG. 9 is a block diagram illustrating an example configuration of an image processing device of a second embodiment of the present invention.

FIGS. 10A, 10B are views illustrating operation of a lowpass filter of the image processing device of the second embodiment and a fourth embodiment of the present invention, where FIG. 10A is a view illustrating an example filter factor of the lowpass filter made of a FIR filter, and FIG. 10B is a view illustrating an example alignment of pixels.

FIG. 11 is a view illustrating the relationship between memory control and processing by the lowpass filter of the image processing device of the second embodiment of the present invention.

FIG. 12 is a view illustrating operation of a data output controlling section of the image processing device.

FIGS. 13A, 13B are illustrating operation of selecting output data of the image processing device, where FIG. 13A is a view illustrating the case where comparison results in the comparator are aligned in pixels, respectively, and the comparison results of all the pixels are “1,” and FIG. 13B is a view illustrating the case where a comparison result of at least one of the pixels is “0.”

FIG. 14 is a block diagram illustrating an example configuration of an image processing device of a third embodiment of the present invention.

FIG. 15 is a block diagram illustrating an example configuration of a highpass filter of the image processing device of the third embodiment and a fourth embodiment of the present invention.

FIGS. 16A, 16B are views illustrating operation of controlling input data and output data of the image processing device of the third embodiment of the present invention, where FIG. 16A is a view illustrating a change of the value of image data, and a change of the image data after the image data passed through a lowpass filter, and FIG. 16B is a view illustrating changes of values of a comparison result of a comparator when the image data of FIG. 16A changes and a control signal of an image output control circuit.

FIGS. 17A, 17B are views illustrating operation of the highpass filter of the image processing device of the third embodiment of the present invention, where FIG. 17A is a view illustrating a change of data output from a FIR filter of FIG. 15, FIG. 17B is a view illustrating a change of data output from a 1/n gain circuit of FIG. 15, and FIG. 17C is a view illustrating a change of the value of image data output from an adder of FIG. 15.

FIG. 18 is a view illustrating an output data when the image data of FIG. 16 is input by the image processing device of the third embodiment of the present invention.

FIG. 19 is a block diagram illustrating an example configuration of an image processing device of a fourth embodiment of the present invention.

FIGS. 20A, 20B are views illustrating operation of a highpass filter of the image processing device of the fourth embodiment, where FIG. 20A is a view illustrating the case where a FIR filter in the highpass filter is a 3×3 FIR filter, and FIG. 20B is a view illustrating the alignment of pixels.

FIG. 21 is a view illustrating the relationship between memory control and processing by a lowpass filter of the image processing device of the fourth embodiment of the present invention.

FIG. 22 is a view illustrating operation of a data output controlling section of the image processing device of the fourth embodiment of the present invention.

FIGS. 23A, 23B are views illustrating operation of selecting output data of the image processing device of the fourth embodiment of the present invention, where FIG. 23A is a view illustrating the case where comparison results in the comparator are aligned in pixels, respectively, and the comparison results of all the pixels are “1,” and FIG. 23B is a view illustrating the case where a comparison result of at least one of the pixels is “0.”

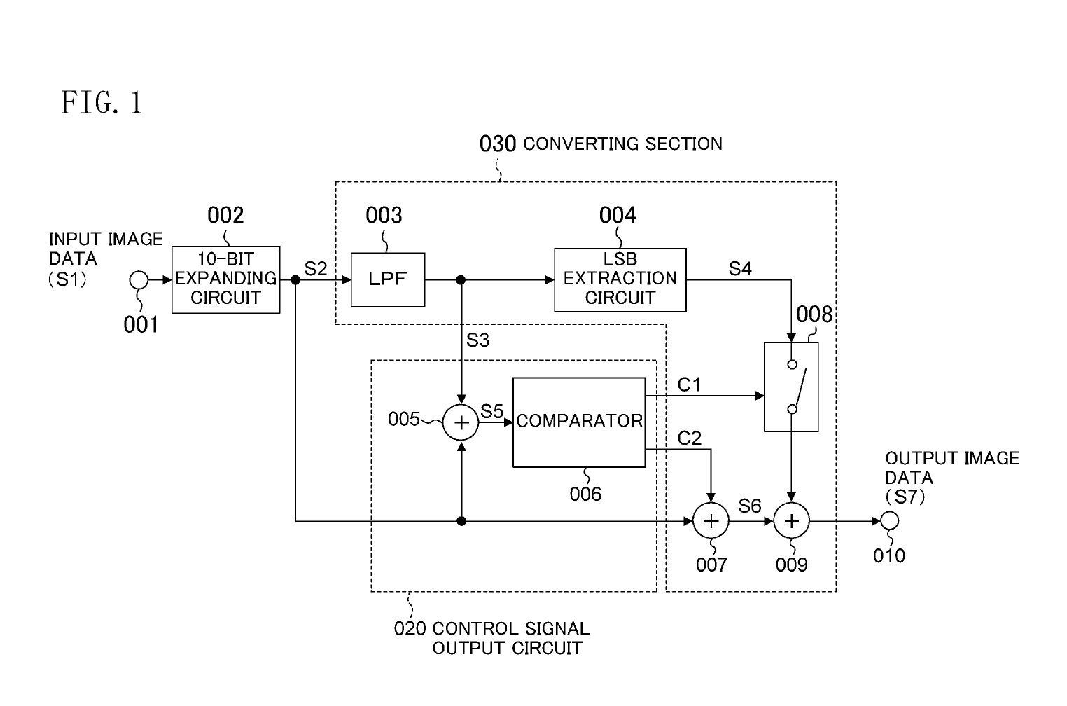

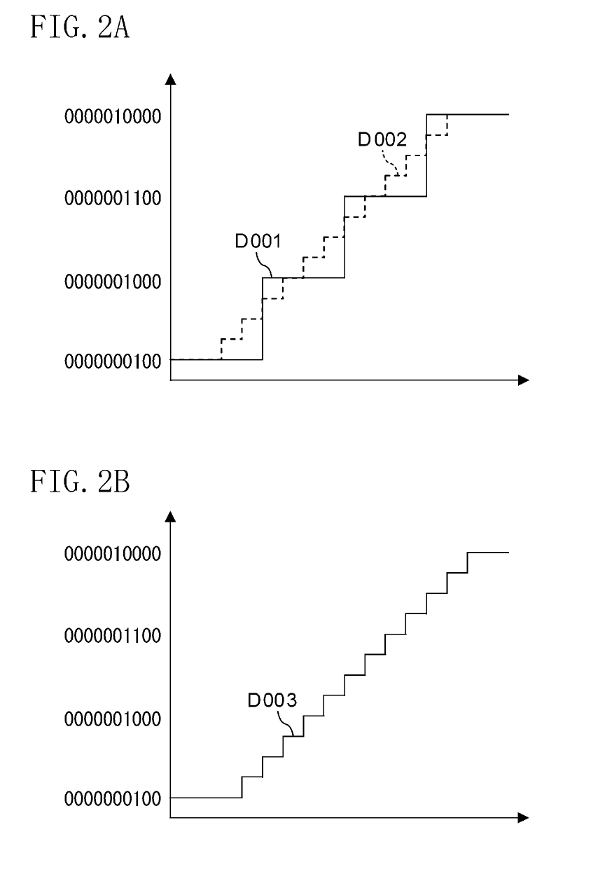

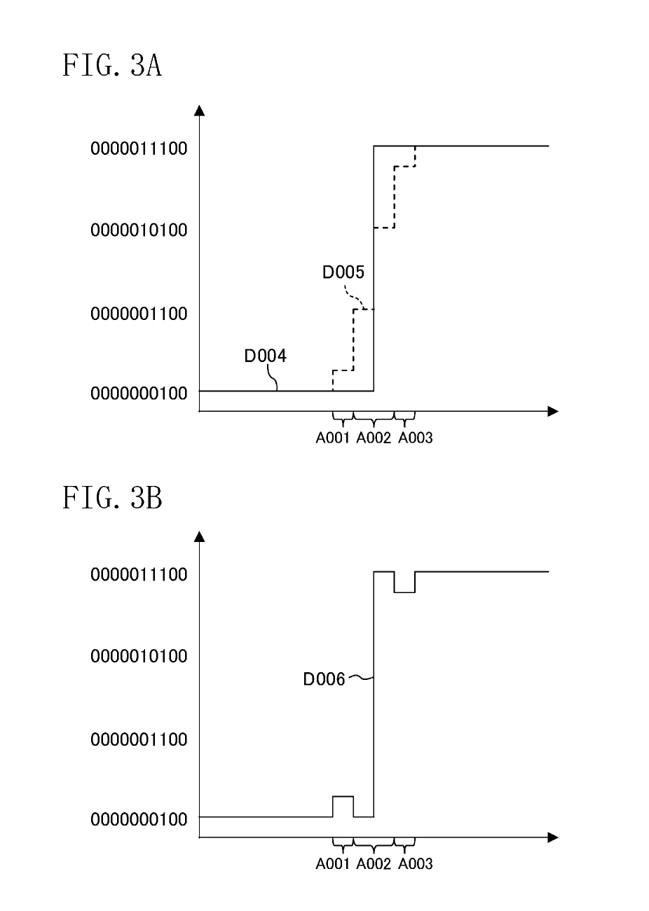

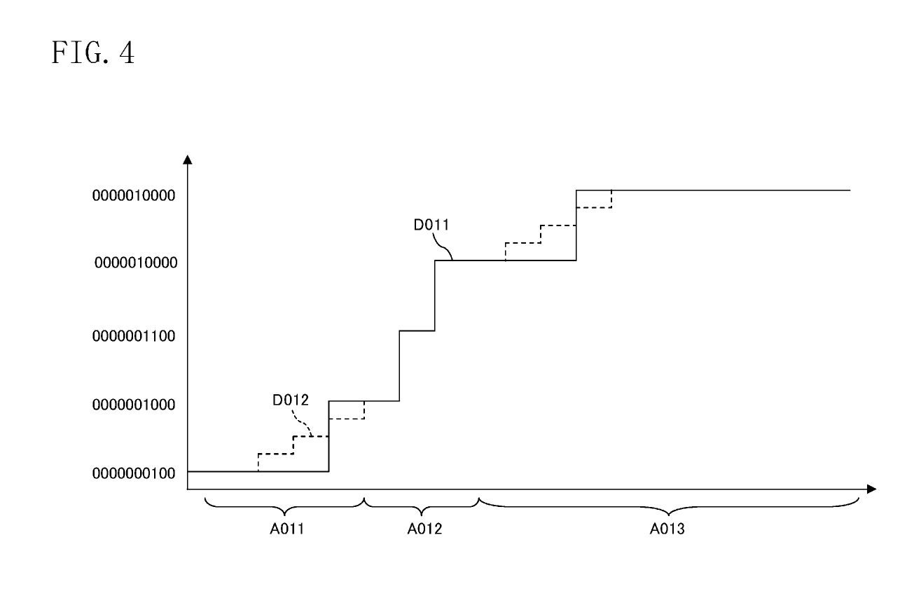

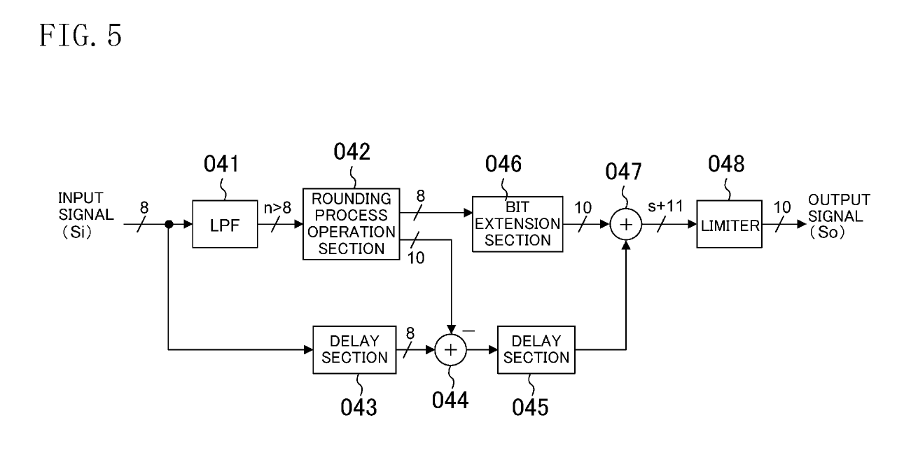

### DETAILED DESCRIPTION

Embodiments of the present invention will be described below with reference to the drawings.

### First Embodiment

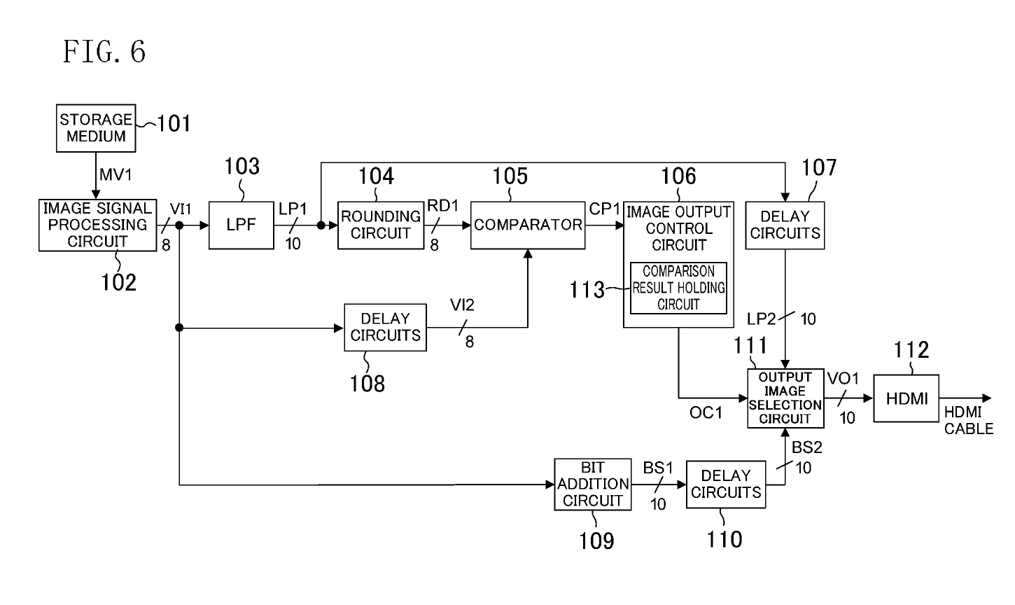

In FIG. 6, an example configuration of a first embodiment of the invention is illustrated. FIG. 6 shows a storage medium 101 in which image contents are stored, an image signal processing circuit 102, a lowpass filter (LPF) 103, a rounding circuit 104, a comparator 105, an image output control circuit 106, delay circuits 107, 108, 110, a bit addition circuit 109, an output image selection circuit 111, and an output circuit (HDMI) 112.

In the storage medium 101, image contents compressed, for example, in MPEG2 format are stored. The image signal processing circuit (input unit) 102 receives image contents MV1 read out of the storage medium 101, and performs signal processing such as a decoding process on the image contents MV1 to output quantized 8-bit image data VI1. The lowpass filter (filter unit) 103 extracts only a low-frequency component of the 8-bit image data VIL and performs bit expansion in the course of an operation during the extraction, thereby outputting 10-bit image data LP1. In this embodiment, as an example, the lowpass filter 103 is made of a finite impulse response (FIR) filter, and it is provided that the transfer function of the FIR filter is indicated by Expression 2 below.

(1+2×Z⁻¹+6×Z⁻²+4×Z⁻³+Z⁻⁴)/16 (Expression 2)

Note that the output of the FIR filter is not divided by 16, but is limited to 10 bits in the most downstream stage of the lowpass filter so that 10-bit image data is output from the lowpass filter 103. In the rounding circuit (rounding unit) 104, two less significant bits of the 10-bit image data LP1 output from the lowpass filter 103 are rounded up if the number is 2 or greater or rounded down if the number is less than 2 to output image data RD1 having the same 8 bits as the input image data VI1. The comparator (comparator unit) 105 receives the image data RD1 output from the rounding circuit 104 and image data VI2 obtained by delaying the image data VI1 by a certain time period in the delay circuit 108. Here, the delay circuit 108 delays the image data VI1 by a time period required for the processing in the lowpass filter 103 and in the rounding circuit 104 to output the image data VI2, so that the image data RD1 and the image data VI2 are input to the comparator 105 at the same timing. The comparator 105 compares the 8-bit image data RD1 with the 8-bit image data VI2, and outputs a comparison result CP1 indicating whether or not the image data RD1 matches the image data VI2. The comparison result CP1 is “1” when the image data RD1 matches the image data VI2, and the comparison result CP1 is “0” when the image data RD1 does not match the image data VI2.

The image output control circuit (image output controller unit) 106 outputs a control signal OC1 to control an output image based on the comparison result CP1 output from the comparator 105. The bit addition circuit (bit addition unit) 109 adds 2 bits to the input image data V11 on the least significant bit (LSB) side of the input image data VI1, and outputs the obtained image data as a 10-bit image data BS1. Here, it is provided that the 2 bits added as an example are “00.” The output image selection circuit (output image selector unit) 111 receives the control signal OC1 output from the image output control circuit 106, image data LP2 obtained by delaying the image data LP1 output from the lowpass filter 103 by a certain time period, and image data BS2 obtained by delaying the image data BS1 output from the bit addition circuit 109 by a certain time period. Here, the delay circuit 107 delays the image data LP1 by a time period required for the processing in the rounding circuit 104, the comparator 105, and the image output control circuit 106 to output the image data LP2. The delay circuit 110 delays the image data BS1 by a time period obtained by subtracting a time period required for the processing in the bit addition circuit 109 from a time period required for the processing in the lowpass filter 103, the rounding circuit 104, the comparator 105, and the image output control circuit 106 to output the image data BS2. Due to the delay circuits 107, 110, the control signal OC1, the image data LP2, and the image data BS2 are input to the output image selection circuit 111 at the same timing. The output image selection circuit 111 selects the image data LP2 or the image data BS2 based on the control signal OC1, and outputs the selected image data as image data V01.

Here, when the control signal OC1 is “1,” the image data LP2 is output as the image data V01, and when the control signal OC1 is “0,” the image data BS2 is output as the image data V01. The 10-bit image data VO1 output from the output image selection circuit 111 is input to the HDMI 112, is subjected to HDMI standard-conforming parallel-serial conversion in the HDMI 112, and is output to a HDMI cable.

The image output control circuit 106 includes a comparison result holding circuit (comparison result holding unit) 113 capable of holding multiple ones of the comparison result CP1, and outputs the control signal OC1 based on the comparison results held in the comparison result holding circuit 113. Here, only when all the comparison results held in the comparison result holding circuit 113 are “1,” “1” is output as the control signal OC1, and when one or more of the comparison results held in the comparison result holding circuit 113 are “0,” “0” is output as the control signal OC1. In the present embodiment, as an example, it is provided that the comparison result holding circuit 113 is capable of holding three comparison results, and the comparison results are deleted in the chronological order from oldest each time when a new comparison result is input.

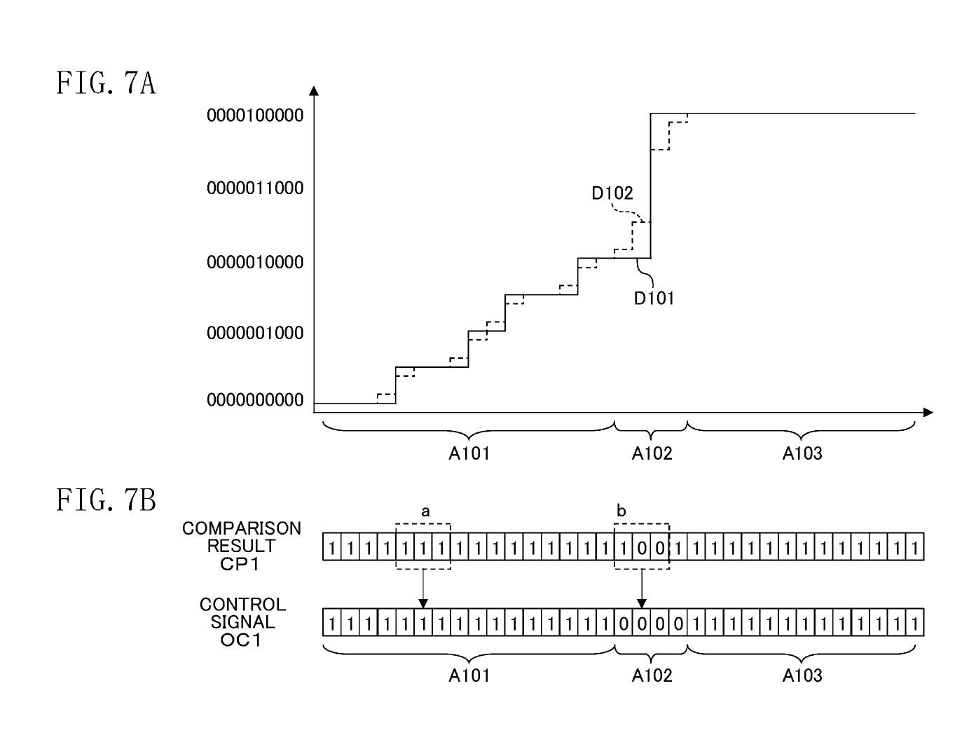

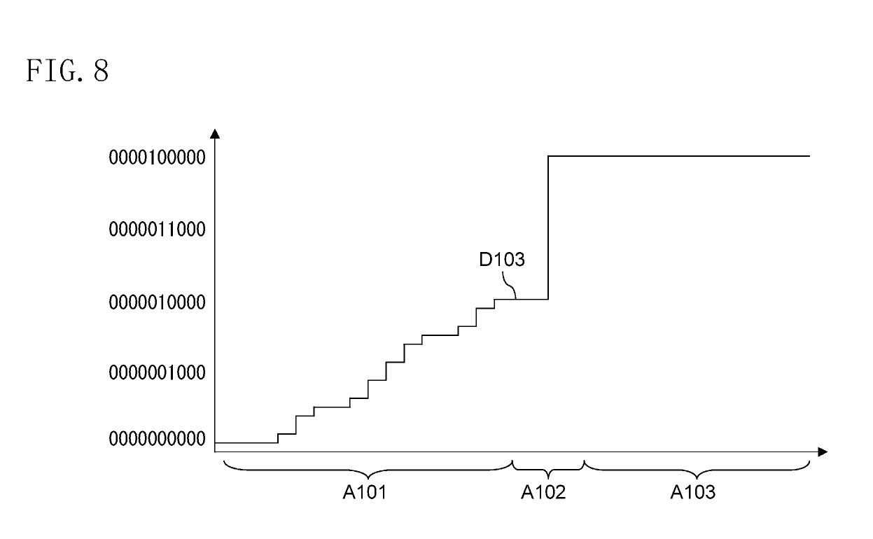

In FIG. 7A, a solid line D101 indicates a change in value of the image data VI1 of FIG. 6, and a broken line D102 indicates a change in the image data LP1 when the image data VI1 which changes as illustrated by the solid line D101 is input to the lowpass filter 103. FIG. 7B illustrates changes of the comparison result CP1 output from the comparator 105 and the control signal OC1 output from the image output control circuit 106 when the image data VI1 which changes as indicated by the symbol D101 of FIG. 7A is input. Moreover, FIG. 8 illustrates the output value of the image data VO1 when the image data VI1 changes as indicated by the solid line D101 of FIG. 7A.

The lowpass filter 103 extracts the low-frequency component, so that image data which smoothly changes as indicated by the broken line D102 of FIG. 7A compared to the change D101 of the image data VI1 is obtained.

Two bits on the LSB side of the image data LP1 which changes as indicated by the broken line D102 are rounded up if the number is 2 or greater, or rounded down if the number is less than 2 in the rounding circuit 104, and the obtained image data is input as the 8-bit image data RD1 to the comparator 105. Here, FIG. 7B illustrates the comparison result CP1 obtained by comparing the data D101 with data obtained by rounding up the two less significant bits of the data D102 if the number is 2 or greater, or rounding up the two less significant bits of the data D102 if the number is less than 2. As illustrated in FIG. 7B, in an area A102, the 8-bit image data RD1 does not match the image data VI1, so that “0” is output as the comparison result CP1. The control signal OC1 output from the image output control circuit 106 is generated based on three comparison results held in the comparison result holding circuit 113. As the symbol a of FIG. 7B, when all the comparison results of 3 pixels held in the comparison result holding circuit 113 are “1,” “1” is output as the control signal OC1. As the symbol b of FIG. 7B, when at least one of the comparison result of 3 pixels held in the comparison result holding circuit is “0,” “0” is output as the control signal OC1. In an area A101 and an area A103 of FIG. 7A, the control signal OC1 is “1,” so that the image data LP2 obtained by delaying the image data LP1 is output as the image data VO1. In the area A102 of FIG. 7A, the control signal OC1 is “0,” so that the image data BS2 obtained by adding the 2 bits to the image data VI1 is output as the image data V01. As a result, the image data VO1 output from the output image selection circuit 110 is indicated as data D103 of FIG. 8, and a smoother signal change is obtained at a changing point of the 1LSB of 8 bits of the data D101 of FIG. 7A.

### Second Embodiment

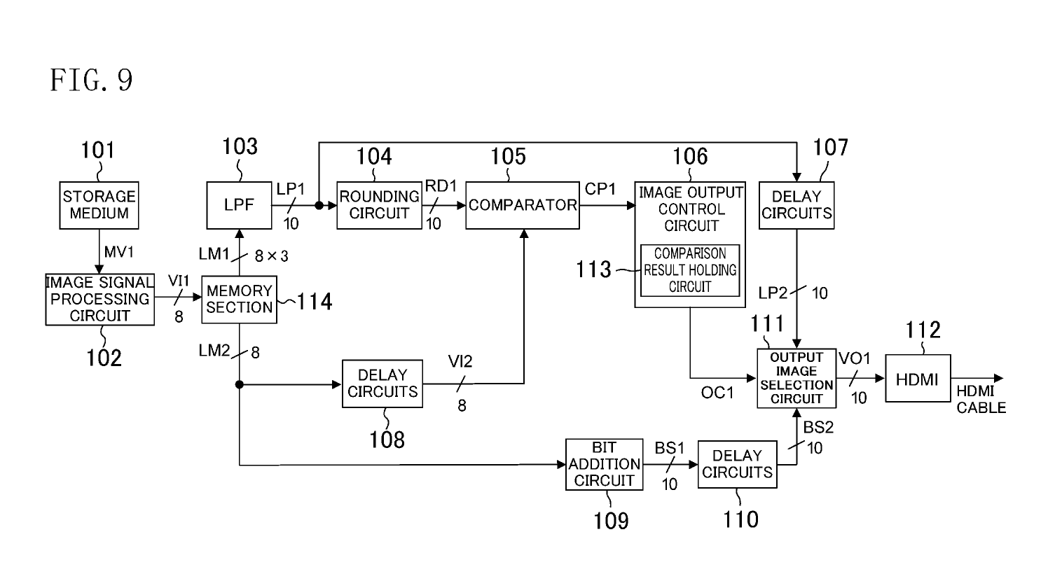

FIG. 9 illustrates an example configuration of a second embodiment of the invention.

The configuration of FIG. 9 is different from the first embodiment in that a memory section (memory unit) 114 is added to the example configuration of the first embodiment of FIG. 6, and the memory section 114 serves as an output source of image data to a lowpass filter 103, image data to a bit addition circuit 109, and image data to a delay circuit 108.

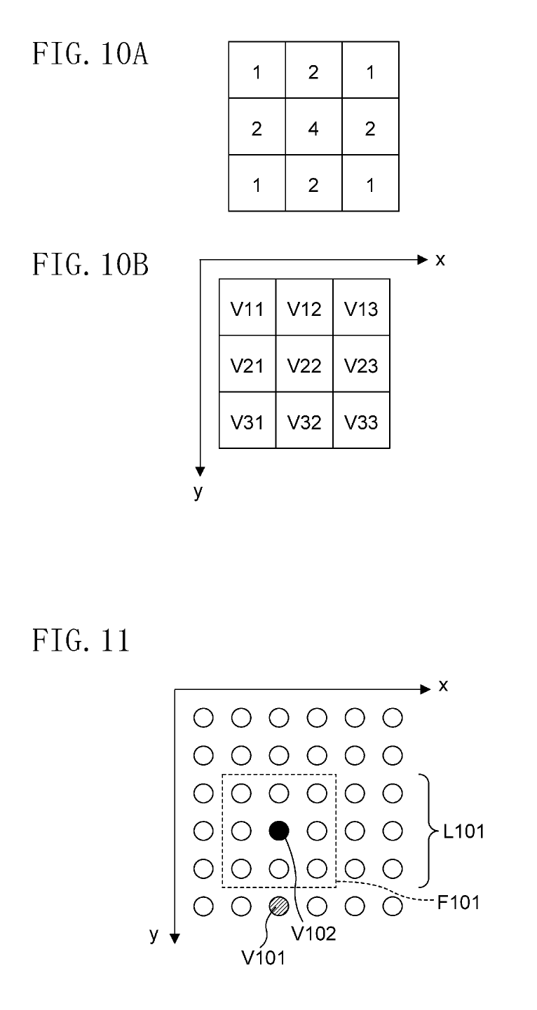

The memory section 114 can hold multiple lines of image data VI1. Here, as an example, it is provided that 3+1 lines of image data can be held. Moreover, the lowpass filter 103 uses image data LM1 of vertically aligned 3 pixels from the memory section 114, and extracts low-frequency components from the image data LM1. Here, as an example, the lowpass filter 103 is made of a 3×3 FIR filter, and has a filter factor as illustrated in FIG. 10A. When the value of a pixel V22 of pixels aligned as illustrated in FIG. 10B is computed, Expression 3 below is obtained.

(((V11×1)+(V12×2)+(V13×1))+((V21×2)+(V22×4)+(V23×2))+((V31×1)+(V32×2)+(V33×1)))/16 (Expression 3)

Note that the output of the FIR filter is not divided by 16, but is limited to 10 bits in the most downstream stage of the lowpass filter so that 10-bit image data is output from the lowpass filter 103.

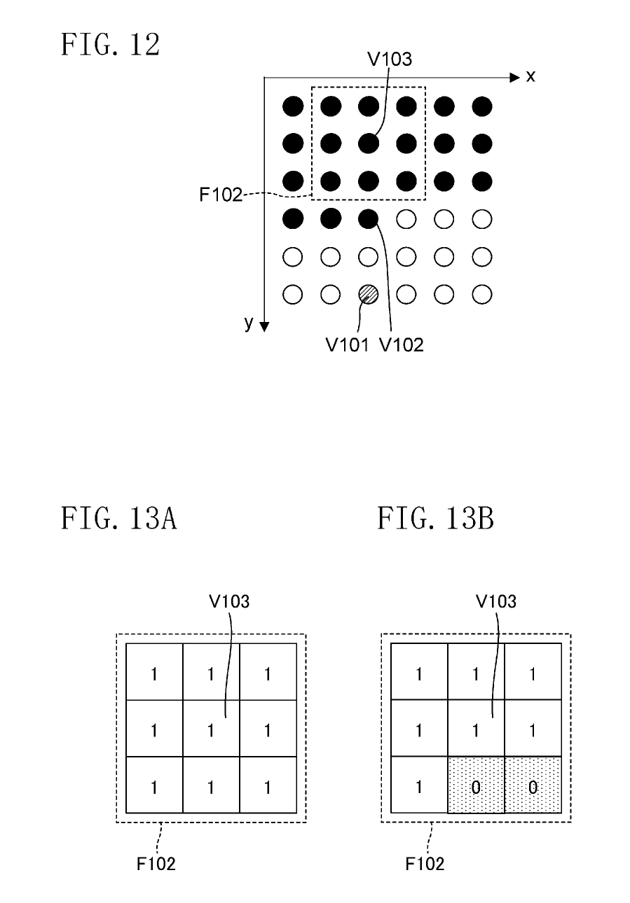

FIGS. 11, 12 are views illustrating the alignment of pixels of the input image data VI1. Here, operation during a time period in which data of a pixel V101 is input to the image data VI1 will be described. As the image data VI1, image data of the pixel V101 is input to the memory section 114. During the time period, pixel data of an area L101 input during preceding time periods is all held in the memory section 114. Thus, the lowpass filter 103 performs the filter operation of Expression 3 on an area F101 in order to extract a low-frequency component using a pixel V102 as a center pixel. Two less significant bits of image data of the pixel V102 obtained by the filter operation are rounded up if the number is 2 or greater, or rounded down if the number is less than 2 in a rounding circuit 104, and the obtained image data is input as 8-bit image data RD1 to a comparator 105. Meanwhile, the memory section 114 outputs data of the pixel V102 as pixel data LM2. The pixel data LM2 is delayed by a certain time period in the delay circuit 108, and the delayed pixel data is input to the comparator 105 as image data VI2 at the same time as image data LP1 of the pixel V102 output from the lowpass filter 103 after the processing in the rounding circuit 104 is input to the comparator 105. The comparator 105 compares the image data RD1 with the image data VI2 to output a comparison result CP1. An image output control circuit 106 holds the input comparison result CP1 in a comparison result holding circuit 113, and generates a control signal OC1 based on the held comparison results. Here, the comparison result holding circuit 113 can hold 3+1 lines of comparison results, and when a new comparison result is held, the comparison results are deleted in the chronological order from oldest. When with respect to the image data of the pixel V102, a comparison result of the comparator 105 is output as the CP1, a comparison result of a pixel illustrated as a black circle in FIG. 12 is held in the comparison result holding circuit 113.

Here, FIGS. 13A, 13B are examples in which comparison results of the comparator 105 are aligned in pixels, respectively. A method for controlling the control signal OC1 will be described with reference to FIGS. 12, 13A, 13B. In order to output data of a pixel V103 of FIG. 12, the image output control circuit 106 outputs “1” as the control signal OC1 when comparison results of all pixels in an area F102 are “1” (in the case of FIG. 13A), and outputs “0” as the control signal OC1 when a comparison result of at least one of the pixels in the area F102 is “0” (in the case of FIG. 13B).

A delay circuit 107 delays the data of the pixel V103 output from the lowpass filter 103 by a certain time period so that the data of the pixel V103 is input to an output image selection circuit 111 at the same time as the control signal OC1, and outputs the delayed data as image data LP2. A delay circuit 110 delays image data BS1 obtained by adding 2 bits to the pixel V103 in the bit addition circuit 109 so that the image data BS1 is input to the output image selection circuit 111 at the same time as the control signal OC1, and outputs the delayed image data as image data BS2. The output image selection circuit 111 outputs the image data LP2 as image data VO1 when the control signal OC1 is “1,” and outputs the image data BS2 as the image data VO1 when the control signal OC1 is “0.” The 10-bit image data VO1 output from the output image selection circuit 111 is input to a HDMI 112, is subjected to HDMI standard-conforming parallel-serial conversion in the HDMI 112, and is output to a HDMI cable.

With the second embodiment, low-frequency components can be planarly extracted from planarly aligned pixels, so that it is possible to obtain two-dimensional smooth images.

### Third Embodiment

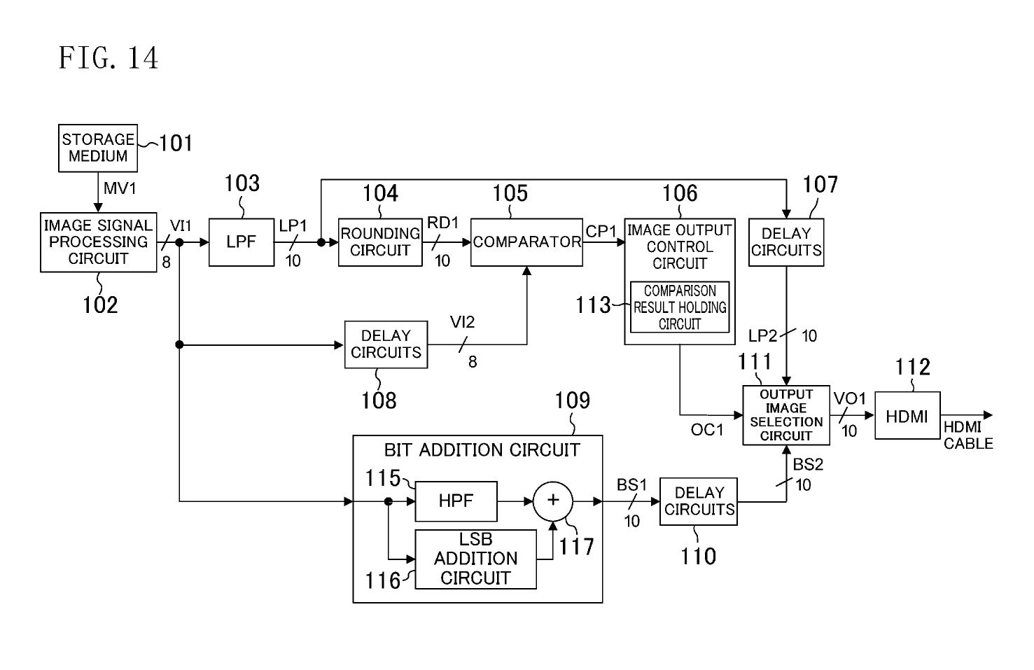

FIG. 14 shows an example configuration of a third embodiment.

FIG. 14 is different from FIG. 6 illustrating the example configuration of the first embodiment in that a bit addition circuit 109 includes a highpass filter (HPF) 115, a LSB addition circuit 116, and an adder 117.

In the bit addition circuit 109, the highpass filter 115 extracts a high-frequency component of 8-bit image data VI1, the LSB addition circuit 116 adds 2 bits to the 8-bit image data VI1 on the LSB side of the 8-bit image data VI1, and outputs the obtained image data as 10-bit image data, and the adder (adder unit) 117 adds the high-frequency component of the image data VI1 to the 10-bit image data obtained by adding the 2 bits to the image data VI1, and outputs the obtained image data as 10-bit image data BS1. Here, as an example, it is provided that values of the 2 bits added in the LSB addition circuit 116 are “00.”

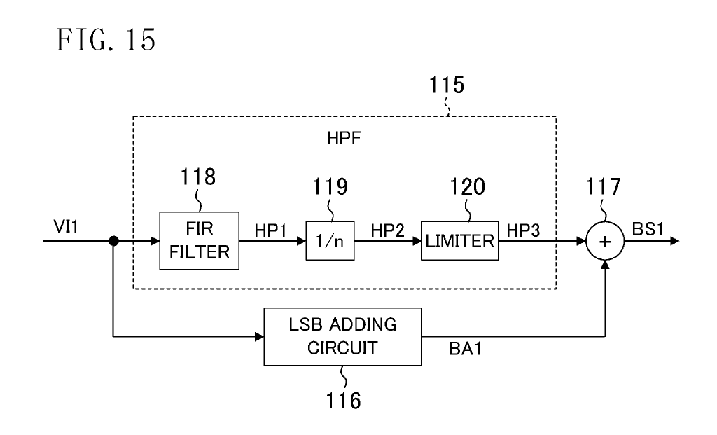

The highpass filter 115 has, for example, a configuration as illustrated in FIG. 15. FIG. 15 shows a FIR filter 118, a 1/n gain circuit 119, and a limiter 120.

The FIR filter 118 is, for example, a filter having a transfer function as Expression 4 below.

(1−4×Z⁻¹+6×Z⁻²−4×Z⁻³+Z⁻⁴)/16 (Expression 4)

Note that the output of the FIR filter is not divided by 16, but is limited to 10 bits in the limiter 120 so that 10-bit image data is output from the lowpass filter 103. The present embodiment 3 includes the FIR filter 118 as the highpass filter in the bit addition circuit 109, but it is also possible to extract a high-frequency component based on the image data VI1 and image data LP1 output from a lowpass filter 103. In this case, the high-frequency component of the image data VI1 can be computed by subtracting the image data LP1 from the image data VI1.

The 1/n gain circuit 119 is configured to reduce the amplitude of an output value from the FIR filter 118 to 1/n, where, for example, n=4. When the value of 10 bits is −2 or less, the limiter 120 limits the value to −2, and when the value of 10 bits is 1 or greater, the 120 limits the value to 1 so that the value of 10 bits is in the range from −2 to +1.

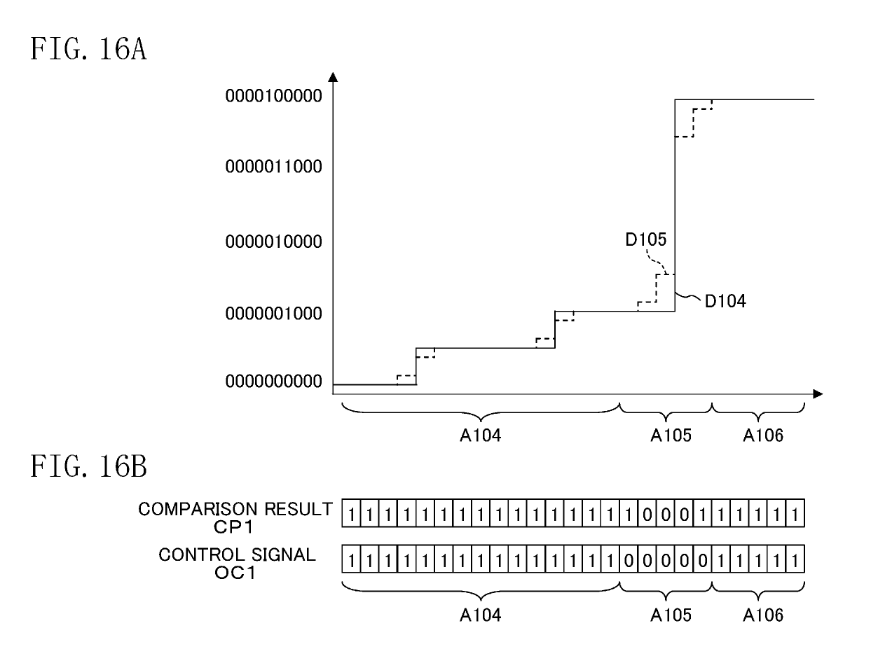

FIG. 16A illustrates a change D104 of the value of the image data VI1 of FIG. 14, and a change D105 of the value of the image data LP1 output from the lowpass filter 103 during the change D104. As FIG. 16A, FIG. 16B illustrates changes of values of a comparison result CP1 output from a comparator 105 and a control signal OC1 output from an image output control circuit 106 when the image data VI1 and the image data LP1 change. According to FIG. 16B, since the control signal OC1 is “1” in areas A104, A106, output image data LP2 from a delay circuit 107 is selected as output image data VO1 from an output image selection circuit 111. Moreover, since the control signal OC1 is “0” in an area A105, output image data BS2 from a delay circuit 110 is selected as the output image data VO1 from the output image selection circuit 111.

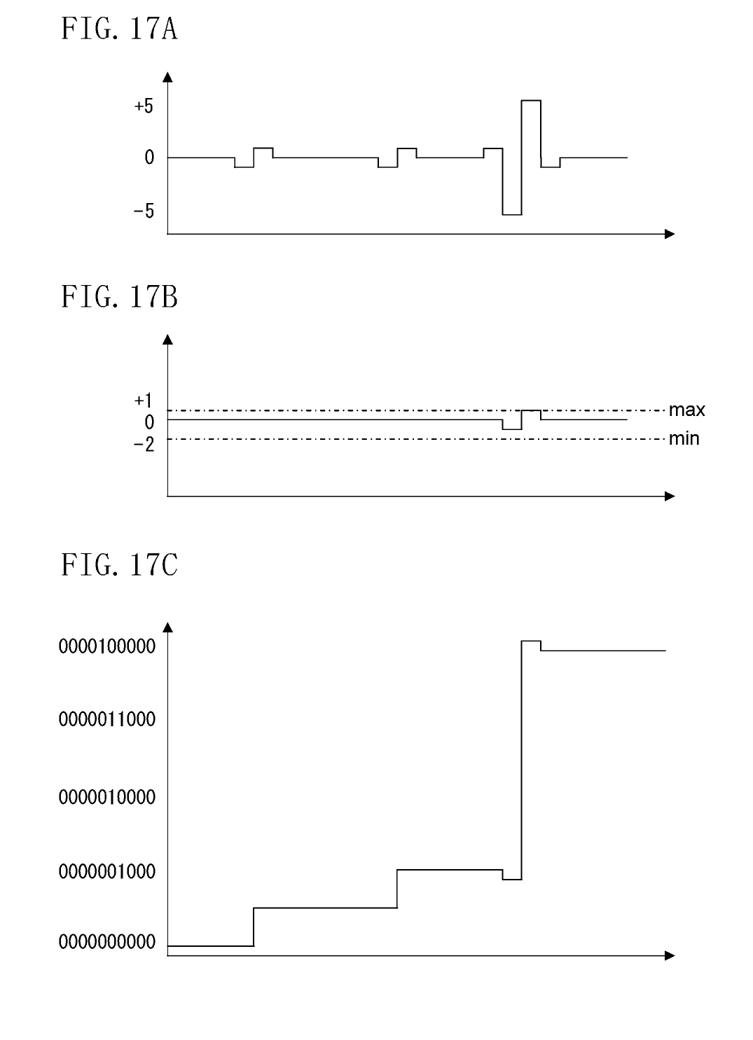

FIGS. 17A-17C illustrate the process of adding bits in the bit addition circuit 109 when the image data VI1 of FIG. 14 changes as the symbol D104 of FIG. 16A. Specifically, FIG. 17A illustrates a change of data HP1 output from the FIR filter 118 of FIG. 15, FIG. 17B illustrates a change of data HP2 output from the 1/n gain circuit 119, and FIG. 17C illustrates a change of the value of the image data BS1 obtained by adding output image data HP3 from the highpass filter 115 to 10-bit image data BA1 obtained by expanding the 8-bit image data VI1.

When the image data VI1 which changes as the symbol D104 of FIG. 16A is input to the FIR filter 118, the FIR filter 118 performs filtering with the transfer function as indicated by Expression 4, so that k-bit data HP1 (k>10) which changes as illustrated in FIG. 17A is obtained. The 1/n gain circuit 119 changes the data amplitude of the data HP1 to 1/n (here, for example, n=4), and outputs data having the changed data amplitude as the data HP2. The data HP2 is limited by the limiter 120 to be in the range from −2 to +1, and is output as the 10-bit data HP3. As illustrated in FIG. 17B, the data HP2 output from the 1/n gain circuit 119 is in the range from min (−2) to max (+1), and thus the data HP3 output from the limiter 120 is output as illustrated in FIG. 17B. The adder 117 adds the data HP3 to the image data BA1 obtained by adding 2 bits (whose values are “00”) in the LSB addition circuit 116 to the image data VI1 which changes as the symbol D104 of FIG. 16A, and outputs the obtained bit data as the 10-bit image data BS1. Here, the image data BS1 changes as illustrated in FIG. 17C.

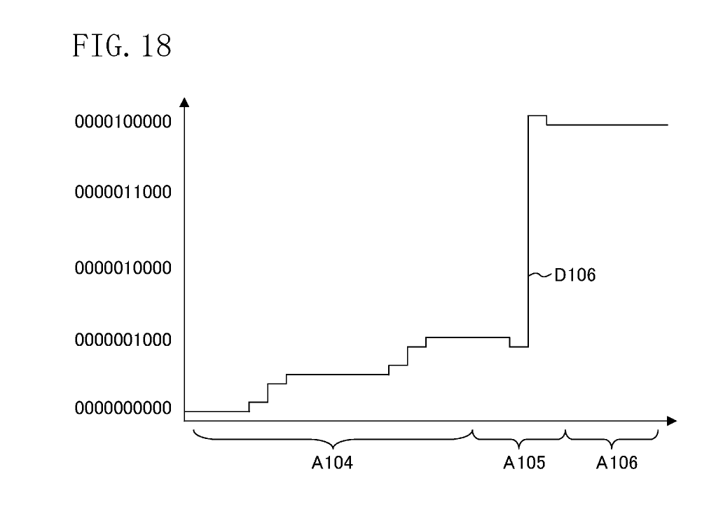

When FIGS. 16A, 17C are put together, the output image selection circuit 111 of FIG. 14 selects and outputs the image data LP2 when the control signal OC1 is “1” (areas A104, A106), and selects and outputs the image data BS2 when the control signal OC1 is “0” (area A105). As a result, the image signal VO1 can be obtained as data which changes as indicated by the symbol D106 of FIG. 18. It can be seen that data which more smoothly changes is obtained in, for example, the area A104 where the change is smooth, and data whose change is emphasized is obtained in, for example, the area A105 where the change is steep.

### Fourth Embodiment

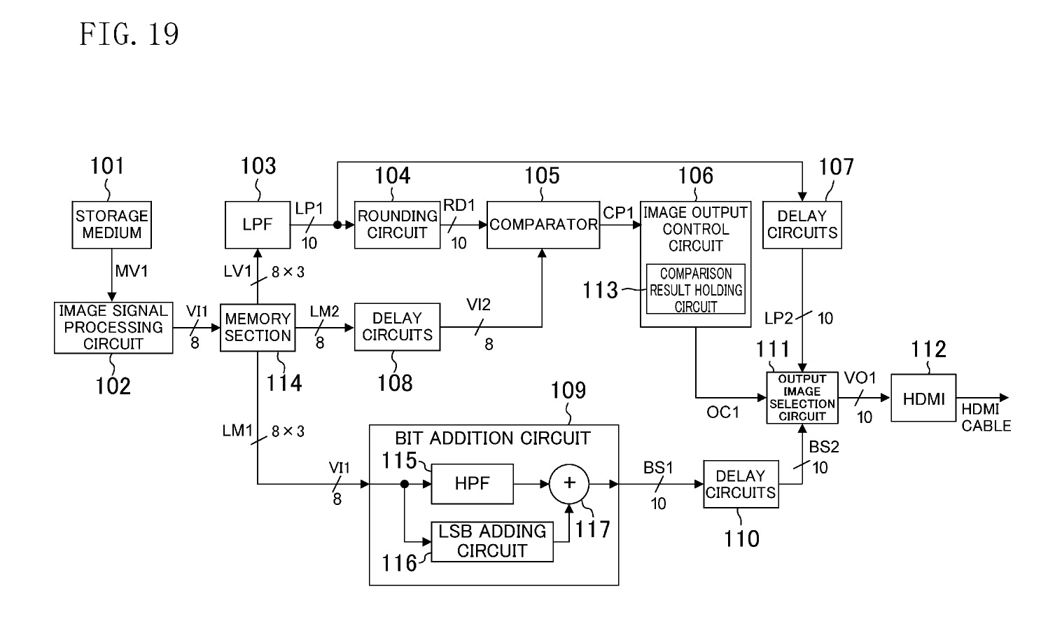

In FIG. 19, an example configuration of a fourth embodiment is shown. The fourth embodiment has a configuration in which the second embodiment and the third embodiment are combined.

A memory section 114 can hold a plurality of lines of image data VI1. Here, as an example, 3+1 lines of image data can be held. Moreover, a lowpass filter 103 extracts a low-frequency component from image data LM1 of vertically aligned 3 pixels from the memory section 114. Here, as an example, the lowpass filter 103 is made of a 3×3 FIR filter, and has a filter factor which is the same as that of the second embodiment of FIG. 10A. In pixels aligned as illustrated in FIG. 10B, an operation expression to compute the value of a pixel V22 is Expression 3 of the second embodiment. Note that the output of the FIR filter is not divided by 16, but is limited to 10 bits in the most downstream stage of the lowpass filter so that 10-bit image data is output from the lowpass filter 103.

Moreover, a highpass filter 115 has a configuration as that of the third embodiment illustrated in FIG. 15. The highpass filter 115 extracts a high-frequency component from the image data LM1 of vertically aligned 3 pixels from the memory section 114.

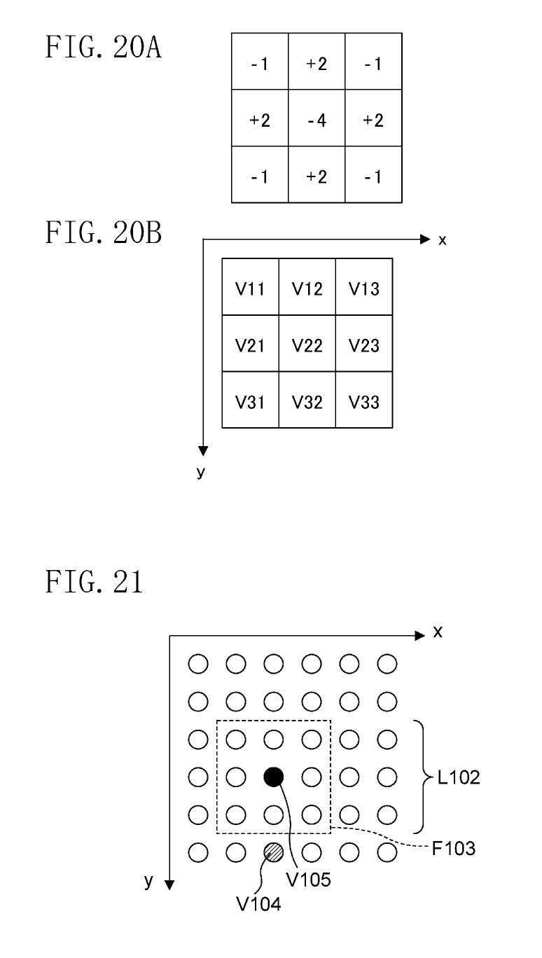

A FIR filter 118 in the highpass filter 115 illustrated in FIG. 15 is a 3×3 FIR filter as illustrated in FIG. 20A. In pixels aligned as illustrated in FIG. 20B, when the value of the pixel V22 is computed, an operation expression as Expression 5 below is obtained.

(((V11×(−1))+(V12×(+2))+(V13×(−1)))+((V21×(+2))+(V22×(−4))+(V23×(+2)))+((V31×(−1))+(V32×(+2))+(V33×(+1))))/16 (Expression 5)

Note that the output of the FIR filter is not divided by 16, but is limited to 10 bits in the limiter 120 so that 10-bit image data is output from the lowpass filter 103.

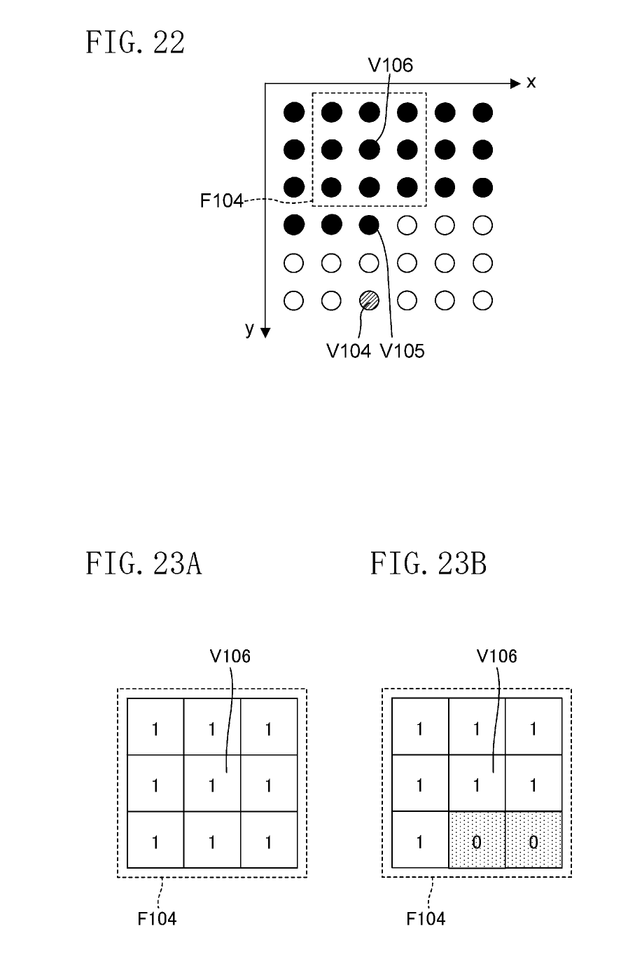

FIGS. 21, 22 illustrate the alignment of pixels of the input image data VI1. Here, operation during a time period in which data of a pixel V104 is input to the image data VI1 will be described. Image data of the pixel V104 is input to the memory section 114 as the image data VI1. During the time period, pixel data of an area L102 input in preceding time period is held in the memory section 114. Thus, in order to extract a low-frequency component using a pixel V105 as a center pixel, the lowpass filter 103 performs a filter operation using Expression 3 of the second embodiment on an area F103. Two less significant bits of the image data V105 obtained by the filter operation are rounded up if the number is 2 or greater, or rounded down if the number is less than 2 in a rounding circuit 104, and the obtained image data is input as 8-bit image data RD1 to a comparator 105.

Meanwhile, data of the pixel V105 from the memory section 114 is output as pixel data LM2. The pixel data LM2 is delayed by a certain time period in a delay circuit 108, and the delayed pixel data is input to the comparator 105 as image data VI2 at the same time as image data LP1 of the pixel V105 output from the lowpass filter 103 after the processing in the rounding circuit 104 is input to the comparator 105.

The comparator 105 compares the image data RD1 with the image data VI2 to output a comparison result CP1. An image output control circuit 106 holds the input comparison result CP1 in a comparison result holding circuit 113, and generates a control signal OC1 based on comparison results held in the comparison result holding circuit 113. Here, the comparison result holding circuit 113 can hold 3+1 lines of comparison results, and to hold a new comparison result, the comparison results are deleted in the chronological order from oldest. When with respect to image data of the pixel V105, a comparison result in the comparator 105 is output as the CP1, a comparison result of a pixel indicated by a black circle of FIG. 22 is held in the comparison result holding circuit 113.

Here, FIG. 23 illustrates an example in which comparison results of the comparator 105 are aligned in pixels, respectively. A method for controlling the control signal OC1 will be described with reference to FIGS. 22, 23. In order to output data of pixel V106 of FIG. 22, the image output control circuit 106 outputs “1” as the control signal OC1 when comparison results of all pixels in an area F104 are “1” (in the case of FIG. 23A), and outputs “0” as the control signal OC1 when a comparison result of at least one of the pixels in the area F104 is “0” (in the case of FIG. 23B).

Meanwhile, a bit addition circuit 109 receives image data LM1 of vertically aligned 3 pixels which is the same as that input to the lowpass filter 103, and the highpass filter 115 extracts a high-frequency component. The FIR filter 118 (see FIG. 15) included in the highpass filter 115 extracts a high-frequency component from an area F103 of FIG. 21 by an operation expression indicated by Expression 5. The signal amplitude of a high-frequency component HP1 obtained in the FIR filter 118 is limited by a 1/n gain circuit 119 to 1/n (here, for example, n=4), and the obtained component is output as a high-frequency component HP2. The limiter 120 limits the signal amplitude (here, for example, to the range from −2 to +1), and outputs the obtained component as a high-frequency component HP3. A LSB addition circuit 116 adds 2 bits (here, for example, values “00”) to the image data V11 on the LSB side of the image data VI1 to output image data BA1. An adder 117 adds the image data BA1 to the high-frequency component HP3 to output 10-bit image data BS1.

A delay circuit 107 delays the data LP1 of pixel V106 output from the lowpass filter 103 by a certain period of time so that the delayed data is input to an output image selection circuit 111 at the same time as the control signal OC1, and outputs the delayed data as image data LP2. A delay circuit 110 delays the 10-bit image data BS1 of the pixel V106 obtained by the expansion in the bit addition circuit 109 by a certain period of time so that the video data is input to the output image selection circuit 111 at the same time as the control signal OC1, and outputs the delayed image data as image data BS2. The output image selection circuit 111 outputs the image data LP2 as the image data VO1 when the control signal OC1 is “1,” and outputs the image data BS2 as the image data VO1 when the control signal OC1 is “0.” The 10-bit image data VO1 output from the output image selection circuit 111 is input to a HDMI 112, and is subjected to HDMI standard-conforming parallel-serial conversion in the HDMI 112, and is output to a HDMI cable.

Therefore, according to the fourth embodiment, a low-frequency component is planarly extracted from planarly aligned pixels, so that two-dimensional smooth image can be obtained, and it is possible to planarly perform an emphasizing process with respect to a high-frequency region where the change is steep.

As described above, the present invention is capable of outputting a high-tone smooth image without degrading an input image when the bit width of quantized image data is expanded and is output, and thus is useful to image processing devices.

What is claimed is:

1. An image processing device configured to reconstitute an original image from quantized digital image data, comprising:
an input unit to which the quantized digital image data is input;
a filter unit configured to perform filter processing on first image data output from the input unit;
a rounding unit configured to change a bit width of second image data output from the filter unit to a same bit width as the first image data;
a comparator unit configured to compare third image data output from the rounding unit to the first image data;
an image output controller unit configured to generate a control signal based on a comparison result output from the comparator unit;
a bit addition unit configured to add a predetermined number of bits to the first image data;
an output image selector unit configured to select the second image data or fourth image data output from the bit addition unit based on the control signal and to output the selected image data; and
an output unit configured to output fifth image data output from the output image selector unit to the outside.

2. The image processing device of claim 1, wherein
the filter unit is a lowpass filter configured to extract a low-frequency component of the first image data.

3. The image processing device of claim 2, wherein
the comparator unit is configured to detect that the first image data matches the third image data.

4. The image processing device of claim 2, wherein
the image output controller unit includes a comparison result holding unit configured to hold the comparison result output from the comparator unit or multiple ones of the comparison result output from the comparator unit, and
the image output controller unit is configured to generate the control signal based on a predetermined plurality of comparison results of the one or more comparison results held in the comparison result holding unit.

5. The image processing device of claim 2, further comprising:
a memory unit configured to hold the first image data, wherein
instead of the first image data, a vertical image data string output from the memory unit is input to the filter unit,
instead of the first image data, sixth image data output from the memory unit is input to the bit addition unit,
instead of the first image data, the sixth image data is input to the comparator unit, and
the vertical image data string includes the sixth image data.

6. The image processing device of claim 2, wherein
the bit addition unit includes a highpass filter configured to extract a high-frequency component of the first image data, and an adder unit configured to add the high-frequency component of the first image data output from the highpass filter to the first image data, and
the bit addition unit outputs data output from the adder unit as the fourth image data.
